(19) United States
(12) Patent Application Publication
(10) Pub. No.: US 2011/0080838 A1
(43) Pub. Date: Apr. 7, 2011

(54) Methods and Arrangements in a Mobile Telecommunication Network

(75) Inventors: Daniel Larsson, Solna (SE); Robert Baldemair, Solna (SE); Dirk Gerstenberger, Stockholm (SE); Lars Lindbom, Karlstad (SE)

(73) Assignee: TELEFONAKTIEBOLAGET LM ERICSSON (PUBL), Stockholm (SE)

(21) Appl. No.: 12/892,240

(22) Filed: Sep. 28, 2010

Related U.S. Application Data
(60) Provisional application No. 61/248,092, filed on Oct. 2, 2009.

(51) Int. Cl. H04L 12/26

(52) U.S. Cl. 370/252

(57) ABSTRACT

Methods and apparatus for distributing available transmit power in a user equipment (UE) to avoid violation of UE power limitations on a Physical Uplink Control Channel (PUCCH) and a Physical Uplink Shared Channel (PUSCH) are described. Available power for transmission on at least the PUCCH is determined and at least one power headroom report indicating available power for transmission on at least the PUCCH is transmitted to a base station.

### TECHNICAL FIELD

The present invention relates to methods and arrangements in a mobile telecommunication network, and in particular to report transmit power headroom in conjunction with simultaneous transmission of physical uplink shared channels and physical uplink control channels.

### BACKGROUND

3GPP Long Term Evolution (LTE) is a project within the 3^{rd} Generation Partnership Project (3GPP) to improve the UMTS standard with e.g. increased capacity and higher data rates towards the fourth generation of mobile telecommunication networks. Hence, the LTE specifications provide downlink peak rates up to 300 megabits per second (Mbps), an uplink of up to 75 Mbit/s and radio access network round-trip times of less than 10 milliseconds (ms). In addition, LTE supports scalable carrier bandwidths from 20 megahertz (MHz) down to 1.4 MHz and supports both FDD (Frequency Division Duplex) and TDD (Time Division Duplex).

LTE uses OFDM (Orthogonal Frequency Division Multiplex) in the downlink and DFT (Discrete Fourier Transform)-spread OFDM in the uplink. The basic LTE downlink physical resource can thus be seen as a time-frequency grid as illustrated in FIG. 1, where each resource element corresponds to one OFDM subcarrier during one OFDM symbol interval.

In the time domain, LTE downlink transmissions are organized into radio frames of 10 ms, each radio frame including ten equally-sized subframes of length T_{subframe}=1 ms as illustrated in FIG. 2.

Furthermore, the resource allocation in LTE is typically described in terms of resource blocks, where a resource block corresponds to one slot (0.5 ms) in the time domain and 12 contiguous subcarriers in the frequency domain. Resource blocks are numbered in the frequency domain, starting with 0 from one end of the system bandwidth.

Downlink transmissions are dynamically scheduled, i.e., in each subframe the base station transmits control information about to which terminals data is transmitted and upon which resource blocks the data is transmitted, in the current downlink subframe. This control signaling is typically transmitted in the first 1, 2, 3 or 4 OFDM symbols in each subframe. A downlink system with 3 OFDM symbols as control is illustrated in FIG. 3.

LIE uses hybrid-automatic repeat request (ARQ), where, after receiving downlink data in a subframe, the terminal attempts to decode it and reports to the base station whether the decoding was successful (ACK) or not (NAK). In case of an unsuccessful decoding attempt, the base station can retransmit the erroneous data.

Uplink control signaling from the terminal to the base station includes hybrid-ARQ acknowledgements for received downlink data; terminal reports related to the downlink channel conditions, used as assistance for the downlink scheduling; and scheduling requests, indicating that a mobile terminal needs uplink resources for uplink data transmissions.

If the mobile terminal has not been assigned an uplink resource for data transmission, the Layer-1/Layer-2 (L1/L2) control information (channel-status reports, hybrid-ARQ acknowledgments, and scheduling requests) is transmitted in uplink resources (resource blocks) specifically assigned for uplink L1/L2 control on a Physical Uplink Control Channel (PUCCH). As illustrated in FIG. 4, these resources are located at the edges of the total available cell bandwidth. Each such resource consists of twelve “subcarriers” (one resource block) within each of the two slots of an uplink subframe. In order to provide frequency diversity, these frequency resources are frequency hopping on the slot boundary, i.e., one “resource” consists of 12 subcarriers at the upper part of the spectrum within the first slot of a subframe and an equally sized resource at the lower part of the spectrum during the second slot of the subframe or vice versa. If more resources are needed for the uplink L1/L2 control signaling, e.g., in case of very large overall transmission bandwidth supporting a large number of users, additional resources blocks can be assigned next to the previously assigned resource blocks.

To transmit data in the uplink the mobile terminal has to have been assigned an uplink resource for data transmission, on a Physical Uplink Shared Channel (PUSCH). In contrast to a data assignment in downlink, in uplink the assignment must always be consecutive in frequency, this to retain the signal carrier property of the uplink as illustrated in FIG. 5.

The middle SC (Single Carrier Frequency Division Multiple Access (FDMA)) symbol (also referred to as DFT-spread OFDM) in each slot is used to transmit a reference symbol. If the mobile terminal has been assigned an uplink resource for data transmission and at the same time instance has control information to transmit, it will transmit the control information together with the data on PUSCH.

Uplink power control is used both on the PUSCH and on PUCCH. The purpose is to ensure that the mobile terminal transmits with sufficient power, but at the same time not be too high, since that would only increase the interference to other users in the network. In both cases, a parameterized open loop combined with a closed loop mechanism is used. Roughly, the open loop part is used to set a point of operation, around which the closed loop component operates. Different parameters such as targets and partial compensation factors for user and control plane are used.

In more detail, the mobile terminal sets P_{PUSCH} the output power for PUSCH according to

P_{PUSCH}(i)=min{P_{CMAX},10 log₁₀(M_{PUSCH}(i))+P_{O}_{_{—}}_{PUSCH}(j)+α·PL+Δ_{TF}(i)+f(i)}[dBm],

where P_{CMAX} is the configured maximum transmit power for the mobile terminal, M_{PUSCH}(i) is the number of resource blocks assigned, P_{O}_{_{—}}_{PUSCH}(j) and α control the target received power, PL is the estimated pathloss, Δ_{TF}(i) is a transport format compensator, and f(i) is the UE (User Equipment) specific offset or ‘closed loop correction’. The function f can represent either absolute or accumulative offsets. The closed loop power control can be operated in two different modes either accumulated or absolute. Both modes are based on a TPC (Transmit power command) which is part of the downlink control signaling. When absolute power control is used, the closed loop correction function is reset every time a new power control command is received. When accumulated power control is used, the power control command is a delta correction with regard to the previously accumulated closed loop correction. The base station can filter the mobile terminals power in both time and frequency to provide an accurate power control operating point for the mobile terminal. The accumulated power control command is defined as f(i)=f(i−1)+δ_{PUSCH}(i−K_{PUSCH}) where δ_{PUSCH} is the TPC command received in K_{PUSCH} subframe before the current subframe i and f(i−1) is the accumulated power control value.

The accumulated power control command is reset when changing cell, entering/leaving RRC active state, an absolute TPC command is received, P_{O}_{_{—}}_{PUCCH} is received and when the mobile terminal (re)synchronizes.

In the case of reset the power control command is reset to f(0)=ΔPᵣₐₘₚᵤₚ+δ_{msg2}, where δ_{msg2} is the TPC command indicated in the random access response and ΔPᵣₐₘₚᵤₚ corresponds to the total power ramp-up form the first to the last random access preamble.

The PUCCH power control has in principle the same configurable parameters with the exception that PUCCH only has full pathloss compensation, i.e. does only cover the case of α=1.

In existing LTE systems, the base station has the possibility to request a power headroom report from the UE for PUSCH transmissions. The power headroom report informs the base station how much transmission power the UE had left for the subframe i. The reported value is within the range of 40 to −23 dB, where a negative value indicates that the UE did not have enough amount of transmit power to fully conduct the transmission of data, or control information.

The UE PUSCH power headroom PH for subframe i is defined as

PH(i)=P_{CMAX}−{10 log₁₀(M_{PUSCH}(i))+P_{O}_{_{—}}_{PUSCH}(j)+α(j)·PL+Δ_{TF}(i)+f(i)}

where P_{CMAX}, M_{PUSCH}(i), P_{O}_{_{—}}_{PUSCH}(j), α(j), PL, Δ_{TF}(i) and f(i) is defined above.

In future LTE releases it will be possible to transmit PUCCH and PUSCH at the same occasion and to transmit/receive on multiple component carriers. With the added possibility for the UE to transmit PUSCH and PUCCH at the same occasion, the scenario of power limitation, i.e., when the UE has reached the maximum transmit power, becomes more likely.

### SUMMARY

In order for a base station to schedule PUSCH effectively, the base station needs to be aware of the available transmission power of the UE. In the prior art, the base station requests a power headroom report from the UE, which indicates how much transmission power is used in the UE based on a PUSCH transmission in subframe i.

Future LTE releases, will give the possibility for the UE to transmit PUSCH (Physical uplink shared channel) and PUCCH (Physical uplink control channel) simultaneously. As both the PUCCH and the PUSCH can be transmitted simultaneously the transmit power in the UE needs to be shared between the two channels.

An improved solution for predicting the available transmission power is therefore desirable.

This can be achieved by taking account of the PUCCH transmission power in a power headroom report. Hence, the UE is requested to either report an individual power headroom report for PUCCH or a combined power headroom report for PUCCH and PUSCH. For example, the combined power headroom report can be transmitted with the individual power headroom report for the PUSCH. The individual power headroom report and the combined power headroom reports can be valid for only one component carrier, e.g., for each individual component carrier, or for the sum of the component carriers.

By using embodiments of the present invention, the base station is able to know how much power the PUCCH will take from the total available transmission power and correspondingly how much power is left for the scheduled PUSCH transmission.

According to an aspect of the invention, there is provided a method in a UE for distributing available transmit power between PUCCH and PUSCH. In the method, available power for transmission on at least the PUCCH is determined, and at least one power headroom report indicating the available power for transmission on at least the PUCCH is transmitted to a base station.

According to an aspect of the invention, there is provided a method in a base station for distributing available transmit power of a UE between PUCCH and PUSCH. In the method, at least one power headroom report indicating available power for transmission on at least the PUCCH is received from a UE and the UE is scheduled based on information of the at least one received power headroom report.

According to an aspect of the invention, there is provided a UE for distributing available transmit power between PUCCH and PUSCH. The UE comprises a processor configured to determine available power for transmission on at least the PUCCH, and a transmitter configured to transmit to a base station at least one power headroom report indicating the available power for transmission on at least the PUCCH.

According to an aspect of the invention, there is provided a base station for distributing available transmit power of a UE between PUCCH and PUSCH. The base station comprises a receiver configured to receive from the UE at least one power headroom report indicating the available power for transmission on at least the PUCCH, and a processor configured to schedule the UE based on information of the at least one received power headroom report.

Among the several advantages of embodiments of the invention is that a base station can predict the available remaining transmission power when the PUSCH and PUCCH are simultaneously transmitted.

### BRIEF DESCRIPTION OF THE DRAWINGS

FIG. 1 illustrates LTE downlink physical resources.

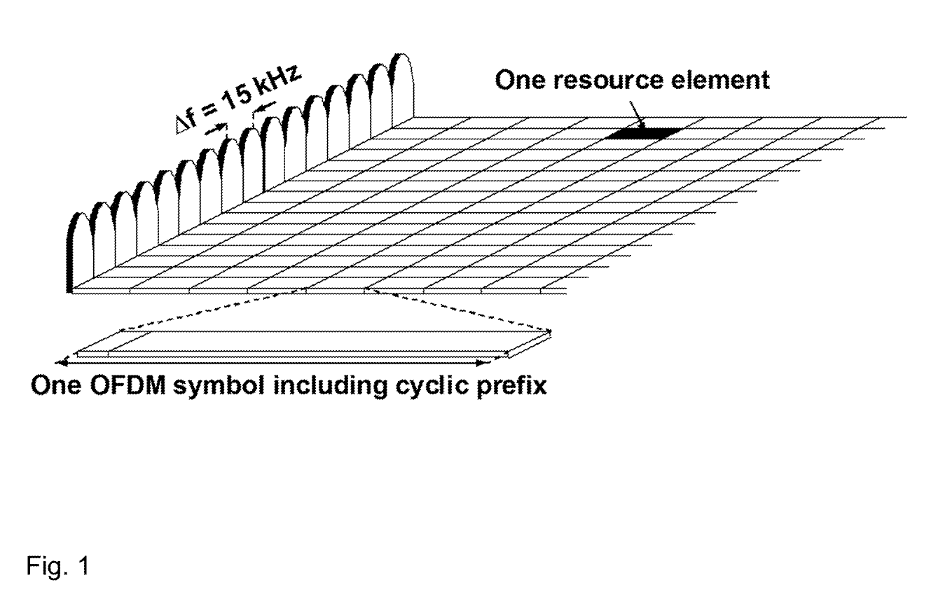

FIG. 2 illustrates an LTE time-domain structure.

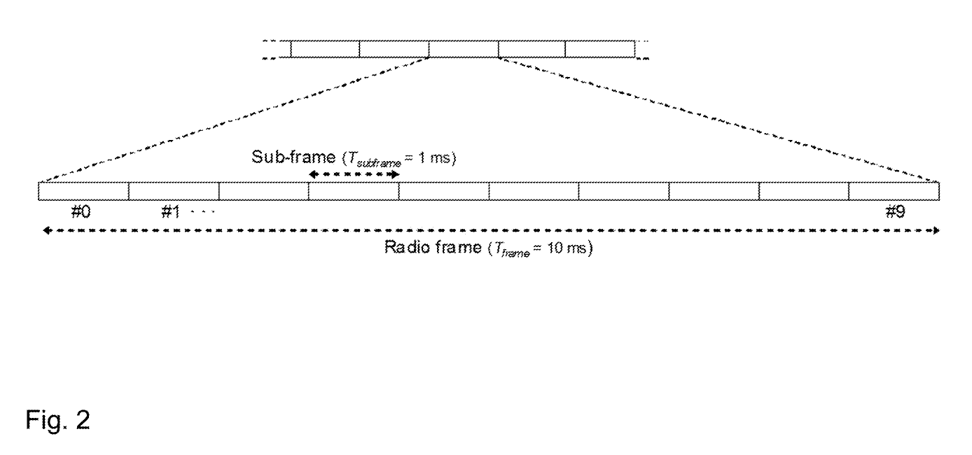

FIG. 3 illustrates downlink subframes.

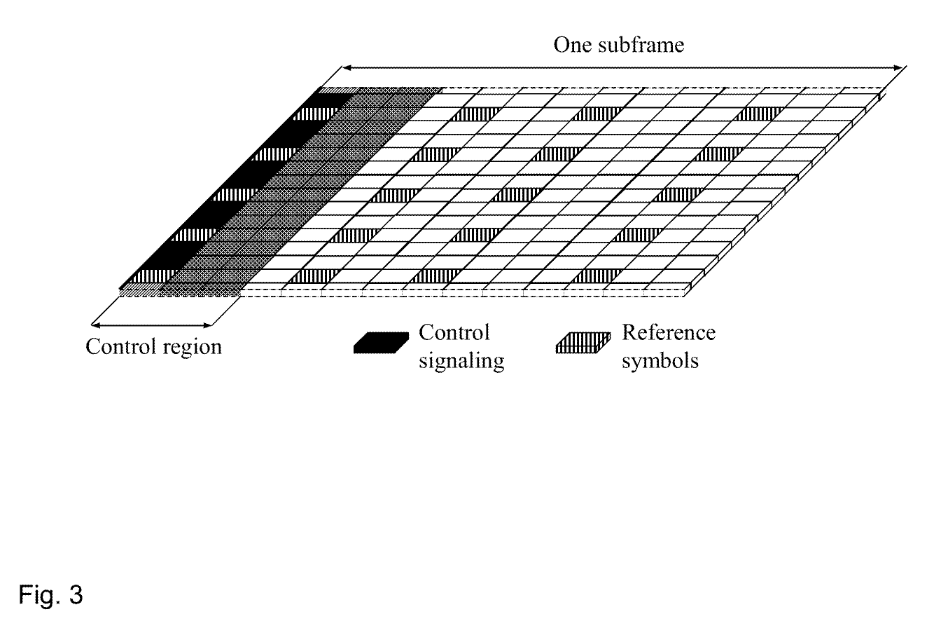

FIG. 4 illustrates uplink L1/L2 control signaling transmission on a PUCCH.

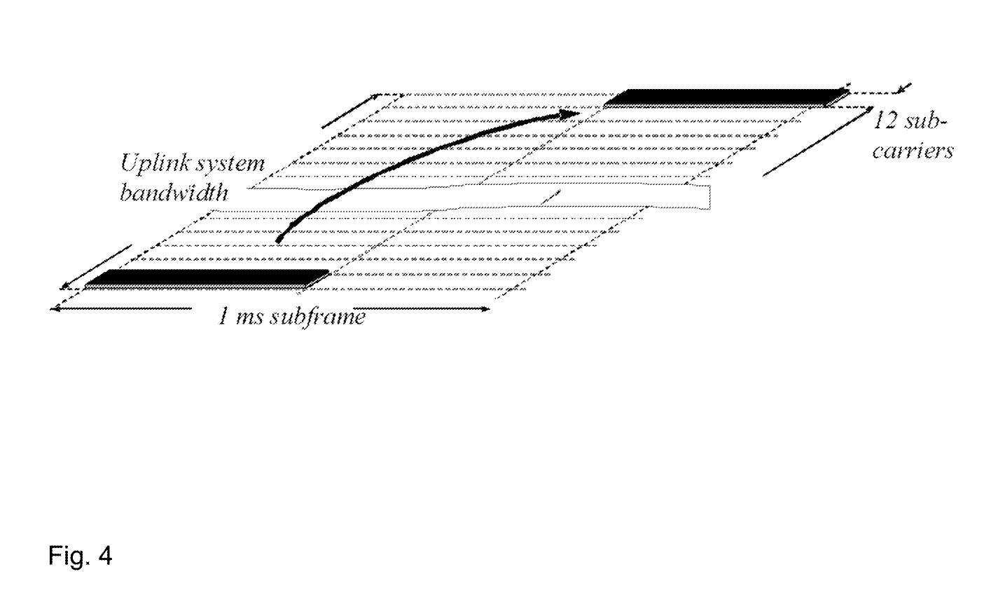

FIG. 5 illustrates PUSCH resource assignment.

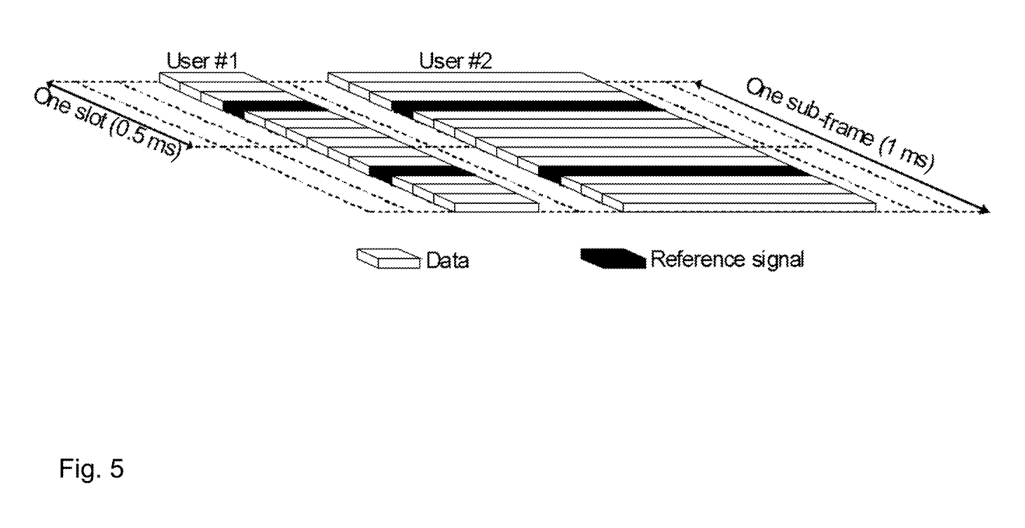

FIGS. 6 and 7 are flowcharts of methods in accordance with the invention.

FIG. 8 illustrates a UE and a base station in accordance with the invention.

### DETAILED DESCRIPTION

Although embodiments of the present invention will be described in the context of an LTE network, the invention can also be implemented in other networks enabling simultaneous transmission of different physical channels.

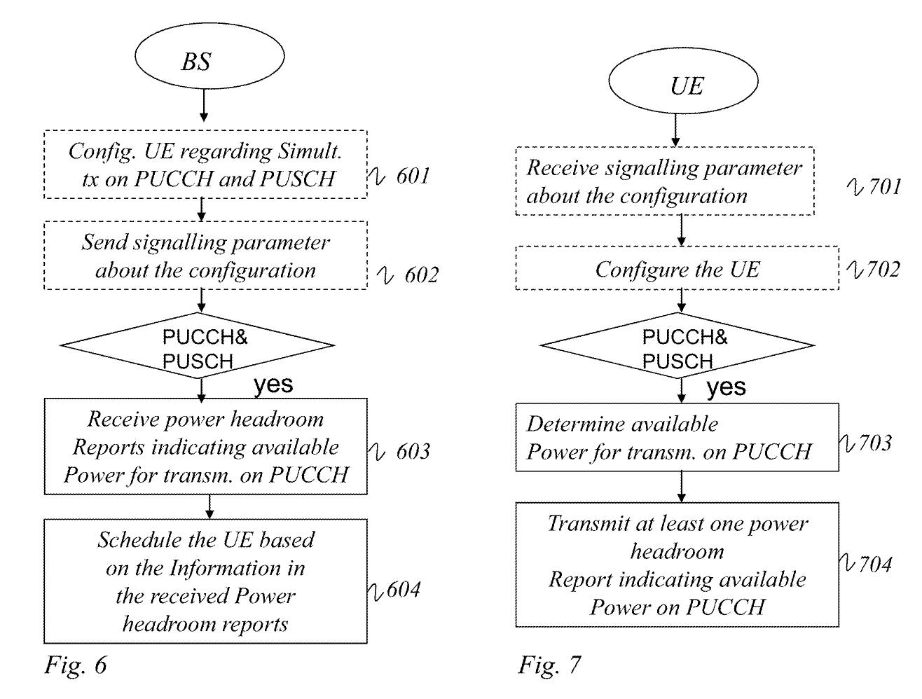

As illustrated by the flowchart of FIG. 6, a base station configures 601 the UE whether or not simultaneous transmission of PUCCH and PUSCH is possible. The base station then signals 602 a parameter to the UE indicating whether simultaneous transmission of PUSCH and PUCCH is possible. The parameter can be signaled via the RRC (Radio Resource Control) protocol or as part of the broadcast system information. Hence, as illustrated by the flowchart of FIG. 7, the UE receives 701 the parameter indicating whether simultaneous transmission of PUSCH and PUCCH is possible, and configures 702 the uplink transmission based on the received parameter according to an embodiment.

As a UE has limited available transmit power, it is desired to schedule the UE such that the available transmission power can be taken into account. Hence in situations when simultaneous transmission of PUCCH and PUSCH is possible, it is desired to be able to take the PUSCH and the PUCCH transmission into account when determining the available UE transmit power.

This is achieved according to embodiments of the present invention by introducing power headroom reports indicating the available power for transmission on at least the PUCCH. This implies that a method in a UE for distributing the available transmit power to avoid violation of UE power limitations on the PUCCH and the PUSCH is provided. A suitable method is illustrated by the flowchart of FIG. 7, which shows that the method comprises determining 703 available power for transmission on at least the PUCCH, and transmitting 704 to a base station at least one power headroom report indicating the available power for transmission on at least the PUCCH.

Accordingly, a corresponding method in a base station for distributing available transmit power of a UE between PUCCH, and Physical Uplink Shared Channel, PUSCH is provided. The base station receives 603 from the UE at least one power headroom report indicating the available power for transmission on at least the PUCCH, and schedules 604 the UE based on information of the at least one received power headroom report.

The power headroom reports can be created in different ways, including according to the embodiments which are further described below.

In a first embodiment, the power headroom report indicates the available power for transmission on the PUCCH, i.e., PH_{PUCCH}=P_{CMAX}−PUCCH power, where P_{CMAX} is the maximum power for the UE and PUCCH power is the power of PUCCH. It should be noted that the existing power headroom report for PUSCH (PH_{PUSCH}) also can be available. An example of how the power headroom report for PUCCH (PH_{PUCCH}), among many possible implementations, can be determined is shown below:

PH_{PUCCH}(i)=P_{CMAX}−{P_{O}_{_{—}}_{PUCCH}+PL+h(n_{CQI},n_{HARQ})+Δ_{F}_{_{—}}_{PUCCH}(F)+g(i)}

where P_{CMAX} is the configured maximum transmit power for the mobile terminal, P_{O}_{_{—}}_{PUSCH}(j), PL is the estimated pathloss, Δ_{F}_{_{—}}_{PUCCH} (F) is provided by higher layers. Each Δ_{F}_{_{—}}_{PUCCH} (F) value is dependent on the PUCCH format. h(n) is also a PUCCH format dependent value, where n_{CQI} corresponds to the number of information bits for the channel quality information and n_{HARQ} is the number of HARQ bits. g(i) is the current PUCCH power adjustment state and i is the current subframe.

In a second alternative embodiment, the existing power headroom report for PUSCH is extended to also include PUCCH, which implies that the power headroom is reported for both PUSCH and PUCCH in the same report referred to as PH_{PUCCH+PUSCH,} where PH_{PUCCH-PUSCH}=Pcmax−(the PUSCH power+the PUCCH power). An example among many possible implementations is shown below:

PH_{PUSCH}_{_{—}}_{and}_{_{—}}_{PUCCH}(i)=P_{CMAX}−{P_{O}_{_{—}}_{PUCCH}+PL+h(n_{CQI},n_{HARQ})+Δ_{F}_{_{—}}_{PUCCH}(F)+g(i)}−{10 log₁₀(M_{PUSCH}(i))+P_{O}_{_{—}}_{PUSCH}(j)+α(j)·PL+Δ_{TF}(i)+f(i)}

where the parameter definitions are specified above. It should also be noted that the power headroom can be expressed in decibels (dB) in the milliwatt (mW) or watt (W) domain. For the power headroom report indicating the available power for transmission on PUSCH and PUCCH, the power headroom report can be defined as:

$${PH}_{PUSCH\_and \_PUCCH} ( i ) = {P}_{CMAX , c} - 10 {log}_{10} ( \begin{matrix}{10}^{( 10 {log}_{10} ( {M}_{PUSCH , c} ( i ) ) + {P}_{O\_PUSCH , c} ( j ) + {α}_{c} ( j ) \cdot PL + {Δ}_{TF , c} ( i ) + {f}_{c} ( i ) ) / 10} + \\ {10}^{( {P}_{0 \_PUCCH} + PL + h ( {n}_{CQI} , {n}_{HARQ} ) + {Δ}_{F\_PUCCH} ( F ) + g ( i ) ) / 10}\end{matrix} ) dB$$

It should be noted that all PH reports can be defined in the mW or W domain and expressed in dB in this way.

According to a third embodiment, the power headroom report for PUSCH and PUCCH can also be used in combination with the existing power headroom report for PUSCH. Thus, the power headroom report indicating the available power for transmission on the PUCCH and the PUSCH is transmitted in combination with a power headroom report indicating the available power for transmission on PUSCH. In this way, it is possible to determine the available power on both PUCCH and PUSCH.

According to a fourth embodiment, the power headroom report for PUSCH and PUCCH can also be used in combination with the power headroom report for PUCCH. Thus, the power headroom report indicating the available power for transmission on the PUCCH and the PUSCH is transmitted in combination with a power headroom report indicating the available power for transmission on PUCCH. In this way, it is possible to determine the available power on both PUCCH and PUSCH.

According to further embodiments, the power headroom report indicates the available transmission power for a given component carrier c. In the example below, the power headroom report indicates the available power for transmission on the PUCCH for a given component carrier c, PH_{PUCCH}(c)=P_{CMAX}−PUCCH power(c), in addition to an existing power headroom report for PUSCH, e.g., defined for a specific component carrier. An example among many possible implementations is shown below:

PH_{PUCCH}(i,c)=P_{CMAX}−{P_{O}_{_{—}}_{PUCCH,c}±PL_{c}+h(n_{CQI},n_{HARQ},c)+Δ_{F}_{_{—}}_{PUCCH}(F,c)+g(i,c)}

where the parameters follow the definitions specified above.

In a further example, the power headroom report indicating the available power for transmission on the PUCCH and the PUSCH can be defined for a given component carrier. Thus, PH_{PUCCH+PUSCH}(c)=Pcmax−(PUSCH power(c)+PUCCH power(c)) can be exemplified as:

PH_{PUSCH}_{_{—}}_{and}_{_{—}}_{PUCCH}(i,c)=P_{CMAX}−{P_{O}_{_{—}}_{PUCCH,c}+PL_{c}+h(n_{CQI},n_{HARQ},c)+Δ_{F}_{_{—}}_{PUCCH}(F,c)+g(i,c)}−{10 log₁₀(M_{PUSCH}(i,c))+P_{O}_{_{—}}_{PUSCH}(j,c)+α(j)·PL_{c}+Δ_{TF}(i,c)+f(i,c)}

where the parameters follow the definitions specified above.

In a yet further example, the power headroom report indicating the available power for transmission on the PUCCH and the PUSCH can transmitted in combination with a power headroom report indicating the available power for transmission on PUSCH. These power headroom reports can be defined for a given component carrier c. The transmission of the different reports can occur simultaneously or at separate instances.

In a yet further example, the power headroom report indicating the available power for transmission on the PUCCH and the PUSCH can transmitted in combination with a power headroom report indicating the available power for transmission on PUCCH. These power headroom reports can be defined for a given component carrier c. The transmission of the different reports can occur simultaneously or at separate instances.

The power headroom report on a given component carrier can be triggered by a pathloss change on the same or on another component carrier. The UE can send a power headroom report for a carrier where the pathloss is changed beyond a certain threshold. Alternatively, a pathloss change on one component carrier can trigger a full power headroom report including reports for all component carriers.

The power headroom reports indicating the available power for transmission on PUCCH, PUSCH and on PUCCH and PUSCH can be defined as a sum for all component carriers used by one UE.

It should be noted that the principles described for the PUSCH can also be applied for the sounding reference signals (SRS). Thus, when simultaneous transmission of SRS and PUCCH occurs, the embodiments of the present invention are also applicable if PUSCH or PUCCH is replaced by SRS.

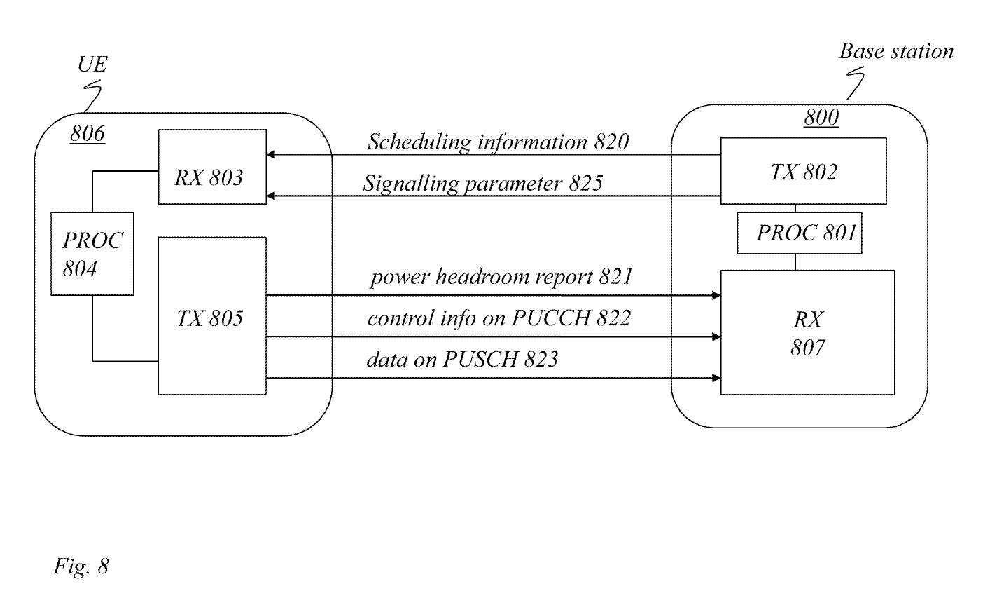

The present invention is also directed to a UE and a base station, also referred to as an Evolved NodeB (eNB) in LTE. The UE is configured to wirelessly communicate with a mobile telecommunication network via base stations. Hence, the UE and the base station comprise antennas, power amplifiers, and other software-programmed processors and electronic circuitry enabling wireless communication. FIG. 8 illustrates schematically a UE and a base station according to embodiments of the present invention.

As depicted in FIG. 8, the UE 806 is adapted to distribute the available transmit power of a UE between PUCCH and PUSCH. The UE comprises a processor 804 configured to determine available power for transmission on at least the PUCCH and a transmitter 805 configured to transmit to a base station at least one power headroom report 821 indicating the available power for transmission on at least the PUCCH. As indicated in FIG. 8, the transmitter is configured to transmit data on PUSCH and control information on PUCCH. Further, the UE comprises a receiver 803 configured to receive a parameter 825 indicating whether simultaneous transmission of PUSCH and PUCCH is possible and to, e.g., receive scheduling information 820. The processor 804 is further configured to configure the uplink transmission based on the received parameter.

Hence, the base station 800 is adapted to distribute the available transmit power of a UE between PUCCH and PUSCH. The base station comprises a receiver 807 for receiving at least one power headroom report 821 indicating the available power for transmission on at least the PUCCH and a processor 801 configured to schedule the UE based on information of the at least one received power headroom report. Furthermore, the base station comprises a transmitter 802 for transmitting scheduling information 820 regarding how to schedule future uplink transmission in the UE, wherein the scheduling information 820 is based on the headroom reports 821. In addition the processor 801 can be configured to configure the UE whether or not simultaneous transmission of PUCCH and PUSCH is possible, and the transmitter 802 can be configured to signal a parameter 825 to the UE indicating whether simultaneous transmission of PUSCH and PUCCH is possible.

It should be noted that the respective processor 804, 801 of the UE and the base station can be one processor or a plurality of processors configured to perform the different tasks assigned to the respective above mentioned processor of the UE and the base station.

It should also be noted that the available power for transmission in the different embodiment is the available remaining power that can be used for transmission on the relevant physical channel such as PUCCH and PUSCH when the power allocated for the respective channel(s) is reduced from the configured maximum transmit power for the mobile terminal.

Modifications and other embodiments of the disclosed invention will come to mind to one skilled in the art having the benefit of the teachings presented in the foregoing description and the associated drawings. Therefore, it is to be understood that the invention is not limited to the specific embodiments disclosed and that modifications and other embodiments are intended to be included within the scope of the invention. Although specific terms are employed herein, they are used in a generic and descriptive sense only and not for purposes of limitation.

What is claimed is:

1. A method in a User Equipment (UE) for distributing available transmit power between a Physical Uplink Control Channel (PUCCH) and a Physical Uplink Shared Channel (PUSCH), comprising:
determining available power for transmission on at least the PUCCH, and
transmitting to a base station at least one power headroom report indicating the available power for transmission on at least the PUCCH.

2. The method of claim 1, wherein an available power for transmission for transmission on the PUCCH and the PUSCH is determined, and the at least one power headroom report indicates the available power for transmission on the PUCCH and the PUSCH.

3. The method of claim 2, wherein the at least one power headroom report indicating the available power for transmission on the PUCCH and the PUSCH is transmitted in combination with a power headroom report indicating an available power for transmission on PUSCH.

4. The method of claim 2, wherein the at least one power headroom report indicating the available power for transmission on the PUCCH and the PUSCH is transmitted in combination with a power headroom report indicating an available power for transmission on PUCCH.

5. The method of claim 1, wherein an available power for transmission on the PUCCH is determined, and the at least one power headroom report indicates the available power for transmission on the PUCCH.

6. The method of claim 1, wherein the at least one power headroom report is valid for a given component carrier c.

7. The method of claim 1, wherein the at least one power headroom report includes a sum for all component carriers.

8. The method of claim 4, wherein the at least one power headroom report indicating the available power for transmission on the PUCCH and the PUSCH is transmitted simultaneously with the power headroom report indicating the available power for transmission on PUSCH.

9. The method of claim 4, wherein the at least one power headroom report indicating the available power for transmission on the PUCCH and the PUSCH is transmitted at a separate time from the power headroom report indicating the available power for transmission on PUSCH.

10. The method of claim 1, further comprising:
receiving a parameter indicating whether simultaneous transmission of PUSCH and PUCCH is possible, and
configuring uplink transmission based on the received parameter.

11. A method in a base station for distributing available transmit power of a User Equipment (UE) between a Physical Uplink Control Channel (PUCCH) and a Physical Uplink Shared Channel (PUSCH), comprising:
receiving from the UE at least one power headroom report indicating available power for transmission on at least the PUCCH, and
scheduling the UE based on information of the at least one received power headroom report.

12. The method of claim 11, wherein the at least one power headroom report indicates an available power for transmission on the PUCCH and the PUSCH.

13. The method of claim 12, wherein the at least one power headroom report indicating the available power for transmission on the PUCCH and the PUSCH is received in combination with a power headroom report indicating an available power for transmission on the PUSCH.

14. The method of claim 12, wherein the at least one power headroom report indicating the available power for transmission on the PUCCH and the PUSCH is received in combination with a power headroom report indicating an available power for transmission on the PUCCH.

15. The method of claim 11, wherein the at least one power headroom report indicates an available power for transmission on the PUCCH.

16. The method of claim 11, further comprising:
configuring the UE whether or not simultaneous transmission of the PUCCH and the PUSCH is possible, and
signalling a parameter to the UE indicating whether simultaneous transmission of the PUSCH and PUCCH is possible.

17. A User Equipment (UE) for distributing available transmit power between a Physical Uplink Control Channel (PUCCH) and a Physical Uplink Shared Channel (PUSCH), comprising:
a processor configured to determine an available power for transmission on at least the PUCCH, and
a transmitter configured to transmit to a base station at least one power headroom report indicating the available power for transmission on at least the PUCCH.

18. A base station for distributing available transmit power of a User Equipment (UE) between a Physical Uplink Control Channel (PUCCH) and a Physical Uplink Shared Channel (PUSCH), the base station comprising:
a receiver configured to receive from the UE at least one power headroom report indicating an available power for transmission on at least the PUCCH, and
a processor configured to schedule the UE based on information of the at least one received power headroom report.
